(19) United States
(12) Patent Application Publication
(10) Pub. No.: US 2007/0271303 A1
(43) Pub. Date: Nov. 22, 2007

(54) Personal file version archival management and retrieval

(76) Inventors: Manuel Emilio Menendez, Miami, FL (US); Jorge Francisco Miranda, Coral Gables, FL (US); Joaquin Higinio de Soto, Coral Gables, FL (US)

Correspondence Address: Soquel Group LLC, P. O. Box 691, Soquel, CA, 95073, US

(21) Appl. No.: 11/436,285

(22) Filed: May 18, 2006

(51) Int. Cl. G06F 17/30

(52) U.S. Cl. 707/200

(57) ABSTRACT

A method for file version control, including intercepting a command to access a target file within a computer file system, determining whether or not the intercepted command is directly related to a user editing session, based on at least one behavioral rule, if the determining is affirmative, then storing a copy of the target file within a file version history archive, and adding a reference to the target file to a queue of active files, when the target file is closed, searching the queue of active files for an entry to the target file, if an entry to the target file in the queue of active files is found, then comparing the target file against the stored copy, if the target file is identical to the stored copy, then deleting the copy of the target file from the file version history archive, and clearing the reference to the target file from the queue of active files. A system and a computer-readable storage medium are also described and claimed.

### FIELD OF THE INVENTION

The present invention relates to data recovery, and more specifically to tracking versions of files that are generated as the files are revised over time.

### BACKGROUND OF THE INVENTION

Nearly all users of computers have had the experience of losing valuable data as a result of hardware or software malfunctions, and user related errors. The most common user related errors include inadvertent file deletions, and overwriting of identically named files. The ease with which a document can be edited and then saved in place inherently causes the loss of previous versions of the document.

During a typical document creation process, an author makes hundreds or thousands of purposeful edits and document saves. Often an author wishes he could retrieve portions of previous revisions days, weeks or years after creating a document. The author may, for example, prefer a prior version of a particular sentence of paragraph over the current version, or wish to recover progressive versions as evidence of original authorship.

Conventional hardware solutions to the problem of version recovery have focused on improving the reliability of storage devices and media. Conventional software solutions range from “undo” operations and over-write alerts, to special-purpose applications that perform scheduled, batch or real-time data backup.

The multiple “undo” operation built into most modern software applications guards well against editing mistakes during a document editing session. However, after the document is saved to disk, the “undo” history is reset and the prior version of the document is overwritten.

Backup applications today typically include incremental backup functionality, whereby older versions of a file are not overwritten by newly edited versions, but are instead added to a backup archive. More advanced applications backup documents incrementally according to a preset schedule. The most reliable incremental backup solutions are based on client/server architectures and require a significant investment in hardware, software and professional setup.

Large enterprises generally employ server-based document management systems, for version recovery. Such systems require procedural user discipline for effective use, since they bypass local file systems and use a remote database instead to save and recall documents. Enterprise document management systems are expensive, require network connectivity, and back office services usually managed by professional IT personnel.

As such, there is a need today for a simple, versatile and reliable file version recovery tool that operates on a standalone desktop computer.

### SUMMARY OF THE DESCRIPTION

The present invention concerns apparatus and methods for file version archiving, management and retrieval. The present invention automatically tracks versions of a file as the file undergoes revisions over time. The present invention operates without requiring additional hardware and without requiring network access, and does not interfere with conventional batch backup applications.

Once installed on a user's computer, the present invention tracks file changes, and preemptively archives a copy of a file about to be edited prior to the file being modified. Archiving copies of files prior to the files being edited obviates the necessity to archive reference copies of the files in the user's hard drive beforehand, as would be the case if the files were archived subsequent to being edited. Starting from the moment the present invention is installed, the last version of a file remains where the user expects it to be, and prior versions, if any, reside in a separate archive.

Using the present invention, access to prior versions of a file is essentially effortless. A user merely selects a file and clicks a right mouse button, to generate a context sensitive pop-up menu that lists archived versions of the selected file, if any. Upon user selection of one of the entries for a prior version of the file, the archived version is opened with read-only privileges using the same application that created the file. The present invention enables the user to retrieve a copy of an older version of the file and copy it into the same directory where the current version resides, or such other directory. The older version preferably has a date & time stamp added to its file name, in order to clearly distinguish it from the current version. After the older version is exported from the invention's archive and changes are made thereto, a new revision history is created for the new file.

In accordance with a preferred embodiment of the present invention, files can be moved, renamed and copied, without losing connection to their revision histories. Depending on user preferences, files can be monitored on local, removable and network drives. Preferably, file revision histories are stored in a central versions archive. Thus, for example, a user may insert a USB drive into his computer and edit a file on the drive. The edited file remains on the USB drive, and a copy of the original unedited version is copied to the central versions archive.

Preferably, the present invention provides a revisions manager and viewer tool. The manager and viewer tool displays files that were edited and have a revision history in the central versions archive. Using the tool, a user adds comments to milestone versions and corresponding key word searches are performed. The present invention also preferably provides export functionality, whereby versions of a file are exported to a zip file; and purge functionality, whereby versions can be manually purged.

A feature of the present invention is that when a file is deleted from a file system, its versions within central archive are maintained. This provides an additional level of protection against inadvertent file deletion.

Preferably, the present invention enables the user to set parameters that limit the size of the central versions archive, the parameters including inter alia a maximum percentage disk space parameter, and a maximum number of versions per file parameter. The present invention preferably also enables a user to set specific file types to be tracked or to be ignored, and specific directories to be tracked or to be ignored. Thus, for example, a user may wish to keep fewer versions of file types for files that tend to be large, and an unlimited number of versions of file types for critical files. The user may change a default location of the central versions archive to a separate or external local drive, or to a network volume in order to provide an additional level of protection.

There is thus provided in accordance with a preferred embodiment of the present invention a method for file version control, including intercepting a command to access a target file within a computer file system, determining whether or not the intercepted command is directly related to a user editing session, based on at least one behavioral rule, if the determining is affirmative, then storing a copy of the target file within a file version history archive, and adding a reference to the target file to a queue of active files, when the target file is closed, searching the queue of active files for an entry to the target file, if an entry to the target file in the queue of active files is found, then comparing the target file against the stored copy, if the target file is identical to the stored copy, then deleting the copy of the target file from the file version history archive, and clearing the reference to the target file from the queue of active files.

There is further provided in accordance with a preferred embodiment of the present invention a system for file version control, including a file access interceptor, for intercepting a command to open a target file within a computer file system, an access filter coupled with the file access interceptor, for determining whether or not the intercepted command is directly related to a user editing session, based on at least one behavioral rule, and an archive manager coupled with the access filter, (i) for storing a copy of the target file within a file version history archive, (ii) for adding a reference to the target file to a queue of active files, (iii) for searching the queue of active files for an entry to the target file, and (iv) for comparing the target file against the stored copy when the target file is closed.

There is additionally provided in accordance with a preferred embodiment of the present invention a computer-readable storage medium storing program code for causing at least one computing device to intercept a command to access a target file, determine whether or not the intercepted command is directly related to a user editing session, based on at least one behavioral rule, if the determining is affirmative, then store a copy of the target file within a file version history archive, and add a reference to the target file to a queue of active files, when the target file is closed, search the queue of active files for an entry to the target file, if an entry to the target file in the queue of active files is found, then compare the target file against the stored copy, if the target file is identical to the stored copy, then delete the copy of the target file from the file version history archive; and clear the reference to the target file from the queue of active files.

### BRIEF DESCRIPTION OF THE DRAWINGS

The present invention will be more fully understood and appreciated from the following detailed description, taken in conjunction with the drawings in which:

FIG. 1 is an illustration of a user interface for viewing and recovering archived versions of files, in accordance with a preferred embodiment of the present invention;

FIG. 2 is an illustration of an alternative way to view and recover archived versions of files, via a Windows system tray, in accordance with a preferred embodiment of the present invention;

FIG. 3 is an illustration of a user interface for a version manager that enables central access to tracked files and versions thereof, in accordance with a preferred embodiment of the present invention;

FIG. 4 is an Illustration of a user interface for a General panel used to configure parameters, in accordance with a preferred embodiment of the present invention;

FIG. 5 is an illustration of a user interface for a File Types panel used to configure parameters, in accordance with a preferred embodiment of the present invention;

FIG. 6 is an illustration of a user interface for a Directories panel used to configure parameters, in accordance with a preferred embodiment of the present invention;

FIG. 7 is an illustration of a user interface for an Archive panel used to configure parameters, in accordance with a preferred embodiment of the present invention;

FIG. 8 is a simplified flowchart of a method for opening a file, in accordance with a preferred embodiment of the present invention;

FIG. 9 is a simplified flowchart of a method for closing a file, in accordance with a preferred embodiment of the present invention;

FIG. 10 is a simplified time line for tracking versions of a file, in accordance with a preferred embodiment of the present invention; and

FIG. 11 is a simplified block diagram of a file version archiving system, in accordance with a preferred embodiment of the present invention.

### DETAILED DESCRIPTION

The present invention concerns an apparatus and method for file version archiving, management and retrieval. Generally, when a user authors a file, the file undergoes a series of revisions over time. Each revision represents an earlier version of the file, and together the revisions represent an entire version history. The present invention automatically tracks versions of a file, as the file is revised over time, and provides a simple interface to access the versions. File versions are stored within a central archive, and may be purged at will.

The present invention is described hereinbelow in terms of “what” it does, and in terms of “how” it is implemented. The “what” description is based on a sample user interface, and the “how” description is based on flowcharts and a system diagram.

### User Interface

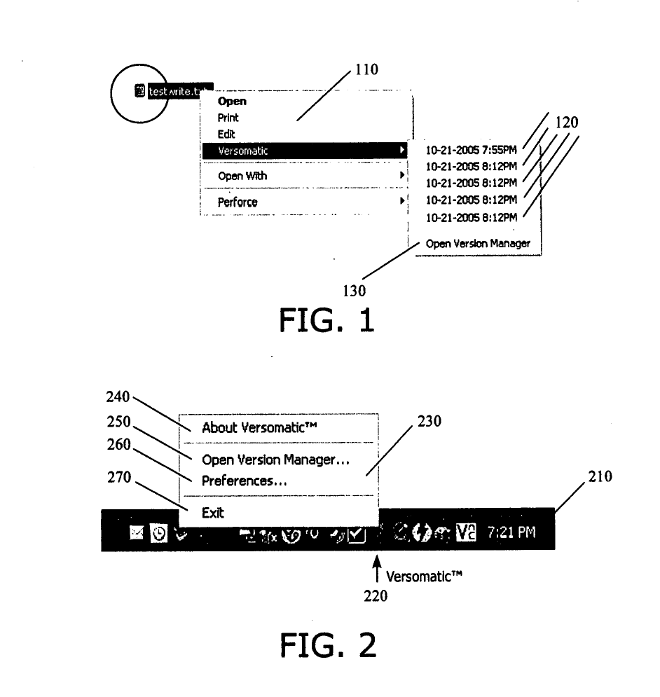

The present invention is very easy to use. Once installed, the invention begins tracking files and saving revisions automatically, without user intervention. FIGS. 1-7 illustrate a sample user interface for accessing archived versions of files using the present invention. FIGS. 1-7 relate to a software application named Versomatic™ that embodies the file version tracking, viewing and recovering mechanisms of the present invention.

It will be appreciated by those skilled in the art that the user interface presented in FIGS. 1-7 is for illustrative purposes only, and is but one example of a wide variety of user interfaces that can be designed for use in conjunction with the present invention.

Reference is now made to FIG. 1, which is an illustration of a user interface for viewing and recovering archived versions of files, in accordance with a preferred embodiment of the present invention. When a user right clicks on a file name, a context sensitive menu 110 listing the file's five most recent versions 120 is displayed. A user may view the file's full revision history by selecting a “Open Version Manager” item 130, in response to which a version manager window is displayed with the selected file's version history.

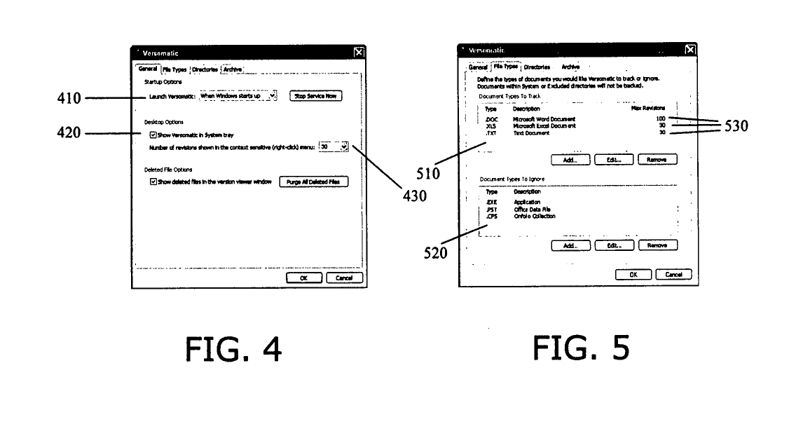

Reference is now made to FIG. 2, which is an illustration of an alternative way to view and recover archived versions of files, via a Windows system tray, in accordance with a preferred embodiment of the present invention. Shown in FIG. 2 is a Windows system tray 210, and a menu 230 that is displayed when an Versomatic™ icon 220 is selected from system tray 210. From menu 230 a user may select “About Versomatic™” 240 to find a version number of the application, or select “Open Version Manager . . . ” 250 to open the file version manager, or select “Preferences . . . ” 260 to open a preferences dialogue, as described in detail with reference to FIGS. 4-7 hereinbelow, or select “Exit” 270 to exit system tray 210.

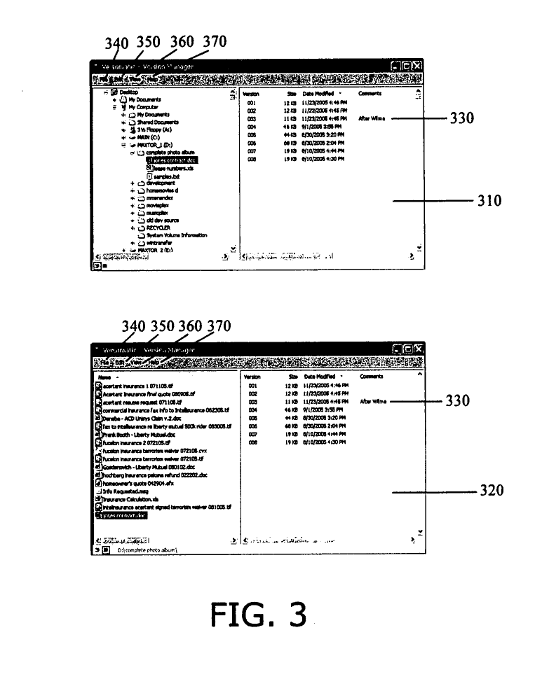

Reference is now made to FIG. 3, which is an illustration of a user interface for a version manager that enables central access to tracked files and versions thereof, in accordance with a preferred embodiment of the present invention. The version manager enables both a hierarchical view 310, which follows the directory structure of tracked files, and a flat view 320, which provides an alphabetical view of all files in the version archive. The hierarchical view is useful when a parent file's path is known, and the flat view is useful when the name of a file is known but not its location within the file system directory. The flat view is also useful for viewing versions of a parent file that was deleted from the file system. Each view 310 and 320 has a left panel that displays a list of files, and a corresponding right panel that displays a list of versions of a selected file.

In either view 310 or 320, when a user clicks on a file in the left panel, a list of file versions is displayed in the right panel, in chronological order. User comments 330 are also displayed in a rightmost column in the right panel. Such comments can be entered directly into the list, and are useful to identify milestone events in the file history.

Each view 310 and 320 includes four menu items 340, 350, 360, 270 as described in TABLE I.

TABLE I
User interface menus

| Item | Sub-item | Description |
|---|---|---|
| File | Export Revisions . . . | Batch export all archived revisions of a |
| | | selected file. The revisions are exported |
| | | to a compressed zip file. |
| | Purge Revision . . . | Manually purges selected revisions. |
| | Exit | Closes the viewer manager window. |
| Edit | Cut, Copy, Paste | Standard editing options applied to the |
| | | current selection, when applicable. |
| | Clear | Deletes the current selection. |
| | Find . . . | Search files by name. |
| | Preferences . . . | Access the Preferences options dialog. |
| View | Hierarchical View | Enable a hierarchical view of the archive. |
| | Flat View | Enable a flat view of the archive. |
| Help | Versomatic Help | Link to the help file. |
| | Shop for Add-Ons | Website link to future enhancements. |
| | Provide Feedback | Website link to a suggestions and |
| | | comments database. |
| | Check for Updates | Website link to check current version |
| | | against a reference version. |
| | About Versomatic | Standard product credits dialog. |

FIGS. 4-7 illustrate a number of powerful user-configurable options for the present invention, to accommodate various workflows. Reference is now made to FIG. 4, which illustrates a user interface for a “General” panel used to configure parameters, in accordance with a preferred embodiment of the present invention. Shown in FIG. 4 is a setting 410 to have the version tracking service of the present invention started automatically or manually. The default setting is automatic startup. Also shown in FIG. 4 is a setting 420 to show Versomatic™ in a Windows system tray, and a setting 430 for the number of revisions to display in the context sensitive menu of FIG. 1. FIG. 4 also includes a setting 440 to hide or show deleted files. In this regard, it is noted that although a file has been deleted, its version history is maintained until purged. A user may purge versions of deleted files by clicking on a “Purge All Deleted Files” button 450.

Reference is now made to FIG. 5, which illustrates a user interface for a File Types panel used to configure parameters, in accordance with a preferred embodiment of the present invention. Shown in FIG. 5 is a list 510 of document types to track for versions, and a list 520 of document types to exclude from tracking. Thus, .DOC files (Word documents), .XLS files (Excel spreadsheets) and .TXT files (text documents) are indicated in FIG. 5 as file types to track; and .EXE files (executables), .PST files (Office data files) and .CFS files (Onfolio collections) are indicated as file types not to track.

File types to track or to ignore can be added or modified by a user at will, and the settings take place immediately. A default number of versions to keep 530 is inserted by default and can be changed in place within the list to any number greater than zero.

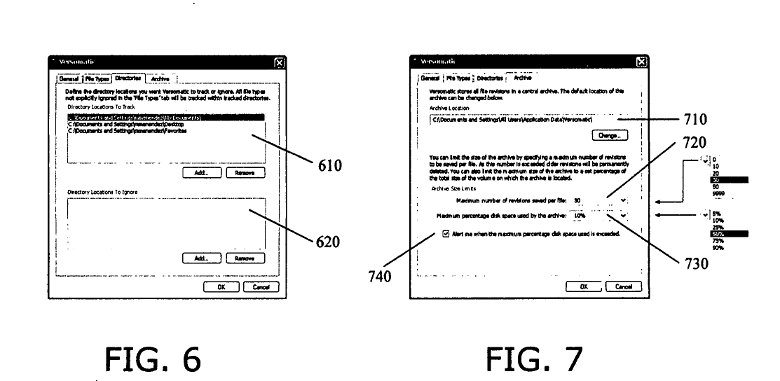

Reference is now made to FIG. 6, which illustrates a user interface for a Directories panel used to configure parameters, in accordance with a preferred embodiment of the present invention. Shown In FIG. 6 is a list 610 of directory locations for files to be tracked for versions, and a list 620 of directory locations for files not to be tracked. By default, the present invention tracks all user documents in a “My Documents” directory and in a “Desktop” directory. The Files Types settings of FIG. 5 preferably override the Directories settings of FIG. 6.

Reference is now made to FIG. 7, which illustrates a user interface for an Archive panel used to configure parameters, in accordance with a preferred embodiment of the present invention. Shown in FIG. 7 is a default location of the version archive; namely, C:\Documents and Setting\All Users\Application Data\Versomatic. The default location can be changed using the panel of FIG. 7, and the present invention moves the version archive to the new location immediately, thereby ensuring its integrity. The Archive panel also includes parameters 720 and 730 to limit the size to which the version archive can expand, and a setting 740 to notify a user when a limit is exceeded. Shown in FIG. 7 is a setting 720 whereby the version archive is limited to a maximum of 30 versions per file, and a setting whereby the version archive is limited to a maximum of 10% of computer disk space.

### Implementation Details

In a preferred embodiment, the present invention operates by intercepting file access at the operating system level using a novel file access interceptor that is situated between an I/O manager and a conventional file system driver. The file access interceptor communications with a background service that manages a file version archive.

When a file open operation is intercepted, the present invention preemptively intervenes and stores a copy of the file within a temporary buffer.

Modern operating systems, such as Windows, MacOS and Linux, may have hundreds of background processes making changes to hundreds of internal files at any given time. Additionally, many applications write to temporary “scratch” files during normal operation. Such activity generally occurs in background, and is transparent to a user. Preferably, the present invention discriminates between file operations not directly related to a user's file editing activities, and file operations that are directly related to a user's file editing activities. In a preferred embodiment, the present invention uses behavioral rules to discriminate between such operations. The behavioral rules preferably indicate when different programs are in use and how they operate. The present invention uses these behavioral rules to ignore file operations that are not the direct result of a user's editing activities.

Preferably, when the present invention has determined that a file operation is about to be performed on a valid target file, it checks to ensure that there is sufficient free memory in the file version archive to add a copy of the target file to the archive. If so, then a preemptive copy of the target file is written to a temporary buffer within the archive, and a reference to the target file is added to a queue of active files. At this point, all that is known is that an application has opened a document with read/write access. The application's user may edit the file, or just read it and close it without making changes.

When a file close operation is intercepted, the present invention searches the queue of active files to determine whether or not there is a reference in the queue to the file being closed. If so, the file being closed is compared with the archived version of the file. If they are exact copies of each other, then a message is sent to the background service instructing it to delete the copy of the file from the archive and to clear the reference to the file from the queue of active files. This avoids archiving false versions of a file. If the file has changed, the copy stored in the temporary buffer is saved in the archive, and the reference to the file is cleared from the queue of active files.

Preferably, the present invention stores file versions in a central database. The database preferably contains (i) exact copies of each file version, (ii) a link or pointer to the parent file, and (iii) comment data or a pointer to comment data for each version. The naming version for the version records is preferably of the form

Complete File Name (including File Type)+Unique Identifier.

The present invention may use a file system as its file version archive. In such case, the directory structure of the parent of each file version is preferably duplicated within the archive. As such, only directories that are necessary to recreate the path to the parent file are created within the archive; and it suffices to append the archive's local root to the root path of the parent file, in order to locate a file version. Preferably, version comments are stored in a separate searchable database file.

Alternatively, the present invention may use a hierarchical or relational database as its file version archive. Moreover, the file version archive may be part of a hosted service accessed remotely via the Internet.

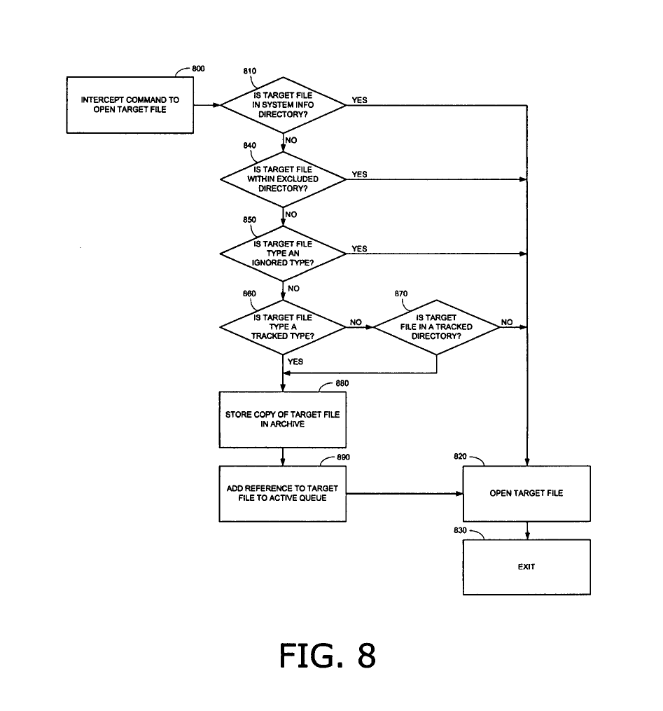

Reference is now made to FIG. 8, which is a simplified flowchart of a method for opening a file, in accordance with a preferred embodiment of the present invention. At step 800 a command to open a target file is intercepted. At steps 810, 840, 850, 860 and 870 a determination is made whether or not the target file is to be tracked.

Specifically, at step 810 a determination is made whether or not the target file is located in a system info directory. Step 810 is included because the system info directory generally exists at the root level of every mounted Windows volume. For some operation systems, step 810 may not be necessary. If the target file is located in the system info directory, then the target file is opened in a conventional manner at step 820 and the procedure exits at step 830.

At step 840 a determination is made whether or not the target file is located in an excluded directory. Excluded directories are described hereinabove with respect to FIG. 6. If the target file is located in an excluded directory, then the target file is opened in a conventional manner at step 820.

Otherwise, if the target file is not located in an excluded directory, then a further determination is made at step 850 whether or not the type of the target file is a type of be ignored for archival purposes. If the type of the target file is an ignored type, then the target file is opened in a conventional manner at step 820.

Otherwise, if the type of the target file is not an ignored type, then a determination is made at step 860 whether or not the type of the target file is a type to be tracked for archival purposes. If the type of the target file is not a type to be archived, then at step 870 a further determination is made whether or not the target file resides within a tracked directory. If the target file does not reside within a tracked directory, then the target file is opened in a conventional manner at step 820.

Otherwise, if the type of the target file is a type to be archived, or if the target file does reside within a tracked directory, then archiving is performed. Specifically, a copy of the target file is preemptively archived as a current version at step 880. At step 890 a reference to the target file is added to a queue of active files. Finally, at step 820 the target file is opened and at step 830 the procedure of FIG. 8 exits.

The following pseudo-code summarizes the logic illustrated in FIG. 8.

```
if( within the hidden “system info” directory == FALSE)
  {
  if( within “excluded directory” == FALSE)
    {
    if( “ignored file type” == FALSE)
      {
      if( “tracked type” == FALSE)
        {
        if( “tracked directory” == TRUE)
          {
          doArchiveFile( );
          }
        }
      else
        {
        doArchiveFile( );
        }
      }
    }
  }
```

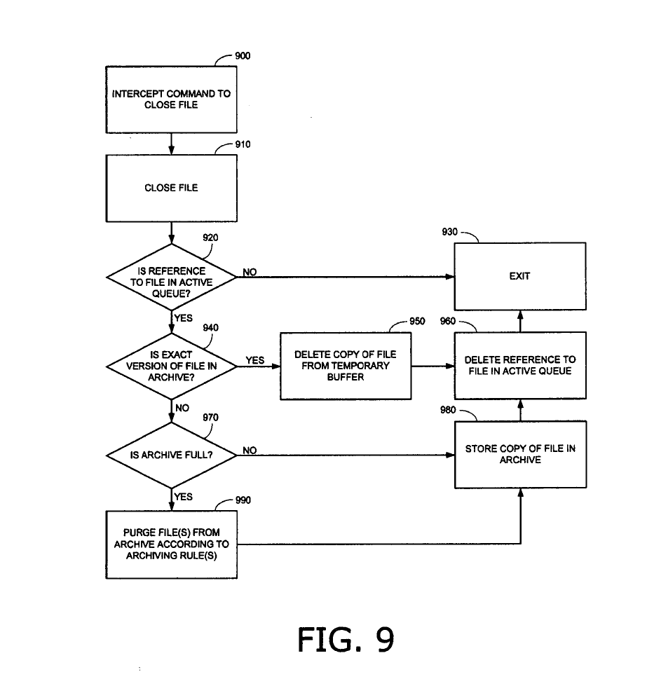

Reference is now made to FIG. 9, which is a simplified flowchart of a method for closing a file, in accordance with a preferred embodiment of the present invention. At step 900 a command to close a file is intercepted. At step 910 the file is closed.

At step 920 a determination is made whether or not a reference to the file that was closed exists in the queue of active files. If not, then the file was not tracked, and at step 930 the flowchart of FIG. 9 exits. Otherwise, if a reference to the file that was closed exists in the queue of active files, then the file was tracked and a version of the file corresponding to the time the file was opened resides in the file version archive. At step 940 the file that was closed is compared using an exact compare, with the version of the file in the archive, to determine whether or not the file was changed. If the exact compare is affirmative, then the file was not changed, and at step 950 the version of the file in the temporary buffer, corresponding to the time the file was opened, is deleted. At step 960 the reference to the file in the queue of active files is cleared. Then, at step 9340 the flowchart of FIG. 9 exits.

Otherwise, if the exact compare at step 940 is negative, then the file was changed after it was opened. At step 970 a determination is made whether or not the archive is full; i.e., whether or not the archive has reached the capacity setting, as described hereinabove with respect to FIG. 7. If the archive is not full, then at step 980 the version of the file that was preemptively saved to the temporary buffer when the file was opened, is saved to the archive, and at step 960 the reference to the file in the queue of active files is cleared. At step 930 the flowchart of FIG. 9 exits.

If it is determined at step 970 that the archive is full, then at step 990 one or more versions of files in the archive are purged, based on one or more archiving rules. For example, if the number of versions of the file that was closed is already at the limit set in FIG. 7, then one of the earlier versions is purged so that the latest version can be archived. After purging files from the archive, the version of the file that was preemptively saved to the temporary buffer when the file was opened, is saved to the archive at step 980, as above.

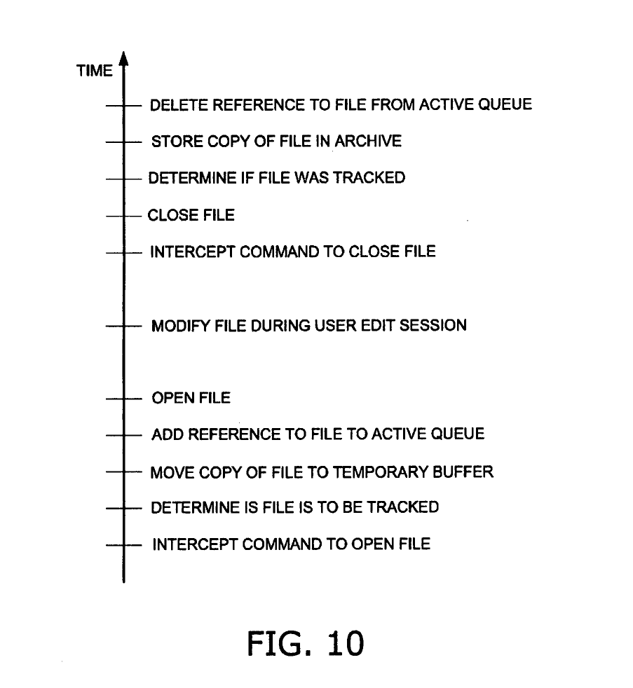

Reference is now made to FIG. 10, which is a simplified time line for tracking versions of a file, in accordance with a preferred embodiment of the present invention. FIG. 10 shows the typical steps from FIGS. 8 and 9 for a file that is tracked, from the time a command is issued to the file system to open the file and its archival process begins, until the time that a command is issued to the file system to close the file and its archival process ends.

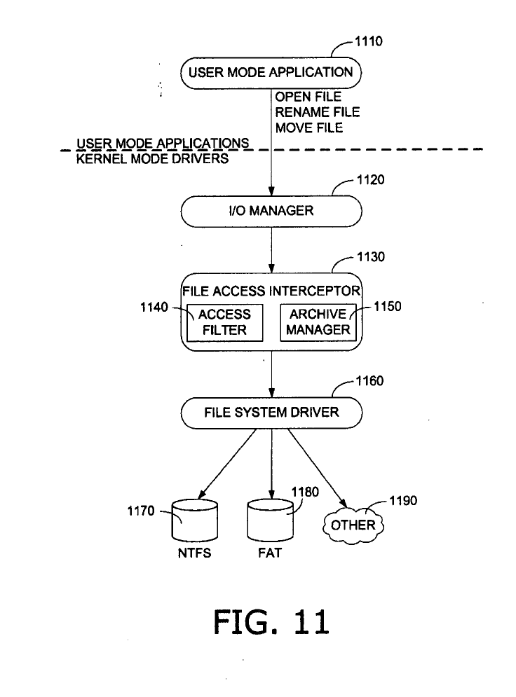

Reference is now made to FIG. 11, which is a simplified block diagram of a file version archiving system, in accordance with a preferred embodiment of the present invention. Shown in FIG. 11 is a user mode application 1110, such as a document editing application or a multimedia editing application. While working with application 1110, a user issues commands to a file system, such as commands to open a file, or to rename a file, or to move a file, or to close a file.

Application 1110 operates in an application, or user mode layer, which processes commands by calling kernel mode drivers. In particular, application 1110 directs its file system calls to an I/O manager 1120, responsible for reading and writing files from the file system.

With prior art operating systems, I/O manager 1120 issues calls to a conventional file system driver 1160, which has access to file system components such as those illustrated in FIG. 11; namely, an NT file system 1170, a file allocation table 1180 and other components 1190.

In distinction, the present invention preferably includes a file access interceptor 1130 that resides between I/O manager 1120 and file system driver 1160, and serves to intercept file access commands. File access interceptor 1130 preferably includes an access filter 1140 for determining whether or not a target file to be accessed is a file that is to be tracked. File access interceptor 1130 preferably also includes an archive manager 1150 for archiving copies of files that represent previous versions of the files. Operation of access filter 1140 and archive manager 1150 is described hereinabove with respect to FIGS. 8 and 9.

It may be appreciated that archive manager 1150 may be remotely located from file access interceptor 1130, and that the versions archive itself may reside within NT file system 1170, or in a remote file system.

Having read the above disclosure, it will be appreciated by those skilled in the art that the present invention enables users to track, manage and retrieve versions of files that correspond to revisions that evolved as the file was modified over time. The present invention can operate on a standalone computer, and does not require network connectivity to a version control or document management system. The present invention has broad application to any types of files.

The present invention makes it easy for a user to track versions of legal documents being negotiated, versions of software being developed, versions of web pages, and versions of media such as pictures, music and video.

In reading the above description, persons skilled in the art will realize that there are many apparent variations that can be applied to the methods and systems described. Thus it may be appreciated that the present invention applies inter alia to data protection, data recovery, and record-keeping.

In the foregoing specification, the invention has been described with reference to specific exemplary embodiments thereof. It will, however, be evident that various modifications and changes may be made to the specific exemplary embodiments without departing from the broader spirit and scope of the invention as set forth in the appended claims. Accordingly, the specification and drawings are to be regarded in an illustrative rather than a restrictive sense.

What is claimed is:

1. A method for file version control, comprising:
intercepting a command to access a target file within a computer file system;
determining whether or not the intercepted command is directly related to a user editing session, based on at least one behavioral rule;
if said determining is affirmative, then:
storing a copy of the target file within a file version history archive; and
adding a reference to the target file to a queue of active files;
when the target file is closed, searching the queue of active files for an entry to the target file;
if an entry to the target file in the queue of active files is found, then:
comparing the target file against the stored copy;
if the target file is identical to the stored copy, then deleting the copy of the target file from the file version history archive; and
clearing the reference to the target file from the queue of active files.

2. The method of claim 1 wherein said storing a copy of the target file within a file version history archive comprises storing the copy of the target file within a temporary memory buffer, and wherein the method further comprises moving the copy of the target file from the temporary buffer to a non-temporary location within the file version history archive if the target file is not identical to the stored copy.

3. The method of claim 1 further comprising determining whether or not the target file should be tracked, based on user preference settings.

4. The method of claim 3 wherein the user preference settings include file types to be tracked.

5. The method of claim 3 wherein the user preference settings include file types not to be tracked.

6. The method of claim 3 wherein the user preference settings include directories to be tracked.

7. The method of claim 3 wherein the user preference settings include directories not to be tracked.

8. The method of claim 1 further comprising storing a pointer to the target file in the file version history archive.

9. The method of claim 1 further comprising storing comment data in the file version history archive.

10. The method of claim 1 further comprising storing a pointer to comment data in the archive.

11. The method of claim 1 further comprising assigning a name to the archived file, the name including the target file name, the target file type, and a unique identifier.

12. The method of claim 1 wherein the file version history archive is a relational database.

13. The method of claim 1 wherein the file version history archive is a file system archive.

14. The method of claim 1 wherein the file version history archive is a hierarchical database.

15. The method of claim 1 wherein the file version history archive is a hosted service remote from the computer.

16. A system for file version control, comprising:
a file access interceptor, for intercepting a command to open a target file within a computer file system;
an access filter coupled with said file access interceptor, for determining whether or not the intercepted command is directly related to a user editing session, based on at least one behavioral rule; and
an archive manager coupled with said access filter, (i) for storing a copy of the target file within a file version history archive, (ii) for adding a reference to the target file to a queue of active files, (iii) for searching the queue of active files for an entry to the target file, and (iv) for comparing the target file against the stored copy when the target file is closed.

17. The system of claim 16 wherein said archive manager stores a copy of the target file within a temporary memory buffer, and moves the copy of the target file from the temporary memory buffer to a non-temporary location within the file version history archive.

18. The system of claim 16 wherein said access filter determines whether or not the target file should be tracked, based on user preference settings.

19. The system of claim 18 wherein the user preference settings include file types to be tracked.

20. The system of claim 18 wherein the user preference settings include file types not to be tracked.

21. The system of claim 18 wherein the user preference settings include directories to be tracked.

22. The system of claim 18 wherein the user preference settings include directories not to be tracked.

23. The system of claim 16 wherein said archive manager stores a pointer to the target file in the file version history archive.

24. The system of claim 16 wherein said archive manager stores comment data in the file version history archive.

25. The system of claim 16 wherein said archive manager stores a pointer to comment data in the file version history archive.

26. The system of claim 16 wherein said archive manager assigns a name to the archived file, the name including the target file name, the target file type, and a unique identifier.

27. The system of claim 16 wherein said archive manager is a relational database manager.

28. The system of claim 16 wherein said archive manager is a file system manager.

29. The system of claim 16 wherein said archive manager is a hierarchical database manager.

30. The system of claim 16 wherein said archive manager is a hosted service remote from the computer.

31. A computer-readable storage medium storing program code for causing at least one computing device to:
intercept a command to access a target file;
determine whether or not the intercepted command is directly related to a user editing session, based on at least one behavioral rule;
if said determining is affirmative, then:
store a copy of the target file within a file version history archive; and
add a reference to the target file to a queue of active files;
when the target file is closed, search the queue of active files for an entry to the target file;
if an entry to the target file in the queue of active files is found, then:
compare the target file against the stored copy;
if the target file is identical to the stored copy, then delete the copy of the target file from the file version history archive; and
clear the reference to the target file from the queue of active files.
